(19) United States
(12) Patent Application Publication
(10) Pub. No.: US 2005/0168392 A1
(43) Pub. Date: Aug. 4, 2005

(54) Antenna efficiency

(75) Inventor: Yoshihiro Hagiwara, Tokyo (JP)

Correspondence Address: PEACOCK MYERS AND ADAMS P C, P O BOX 26927, ALBUQUERQUE, NM, 871256927, US

(73) Assignee: Cocomo Mb Communications, Inc., Tokyo (JP)

(21) Appl. No.: 11/029,558

(22) Filed: Jan. 4, 2005

Related U.S. Application Data
(60) Provisional application No. 60/534,541, filed on Jan. 5, 2004.
(60) Provisional application No. 60/619,336, filed on Oct. 14, 2004.

(51) Int. Cl. H01Q 13/00

(52) U.S. Cl. 343/773; 343/774

(57) ABSTRACT

A method and apparatus for improving transmission and/or reception of electromagnetic waves in areas where such waves are weak.

### CROSS-REFERENCE TO RELATED APPLICATIONS

This application claims priority to and the benefit of the filing of U.S. Provisional Patent Application Ser. No. 60/534,541, entitled “Apparatus and Method for Improving Communication Efficiency”, filed on Jan. 5, 2004. This application also claims priority to and the benefit of the filing of U.S. Provisional Patent Application Ser. No. 60/619,336, entitled “Apparatus and Method for Improving Communication Efficiency”, filed on Oct. 14, 2004. The specifications and proposed claims of these applications are incorporated herein by reference.

### BACKGROUND OF THE INVENTION

1. Field of the Invention (Technical Field)

The present invention relates to methods and apparatus for improving communication efficiency, particularly for improving communication efficiency for cellular phone and wireless LANs as through exterior antenna or a waveguide.

2. Description of Related Art

Note that the following discussion refers to a number of publications by authors and year of publication, and that due to recent publication dates certain publications are not to be considered as prior art vis-à-vis the present invention. Discussion of such publications herein is given for more complete background and is not to be construed as an admission that such publications are prior art for patentability determination purposes.

Currently, antennas used in wireless LAN, cellular phones, GPS, and TVs, etc., are typically single-use antennas with frequency bands ranging from MHz to tens of GHz. Since frequency band (wavelength range) is determined by use, these antennas are designed to be tuned to a specific frequency. For example, IEEE802.11b (wireless LAN) uses a 2.4 GHz band frequency. Since single use antennas, have reduced efficiency when used for numerous frequencies, use of such antennas for multiple frequencies results in limited receiving areas and thus require greater transmitting power.

Since discone antennas have the outstanding characteristic of broadband capability, it is possible that one such antenna may be used for multiple services, i.e. services which require different frequency ranges. However, the gain of a discone antenna is lower than that of a single-use antenna; to date, this reduced performance has prevented the practical use of discone antennas for multiple uses.

The practical use of discone antennas for multiple services can progress if the T/R efficiency is improved. This would have a dramatic effect on personal services such as wireless LANs, cellular phones, GPS, etc., since they could all be provided with just one antenna.

U.S. patent application Ser. No. 10/412,371 entitled “Antenna”, U.S. patent application Ser. No. 10/160,747 entitled “Exciter System and Excitation Methods for Communications Within and Very Near to Vehicles” and U.S. patent application Ser. No. 635,402, entitled “In-Vehicle Exciter”, which are incorporated herein by reference, disclose a modified discone exciter, which is used for comimunications within a vehicle and other structures. The present invention is applicable to modified discone antennas as well as other types of antennas.

### BRIEF SUMMARY OF THE INVENTION

A primary object of the present invention is to improve transmission and/or reception of electromagnetic waves.

The present invention relates to an electromagnetic waveguide including a first antenna disposed in an area where a transmitted signal is weak, a second antenna disposed in an area where a transmitted signal is stronger than in the first area, and a conductor electrically connecting the first and second antennas. At least one of the antennas can have a wide bandwidth. At least one of the antennas can be a discone antenna. The first and/or second antenna can be an assembly of more than one antenna. All of the antennas can be discone antennas.

The waveguide of the present invention can have the first antenna disposed in an inner portion of a building. The second antenna is optionally disposed near an outer portion of a building, on an outer portion of a building, and/or outside of a building. The first antenna can be disposed within an internal portion of a building while the second antenna can simultaneously be disposed in an area which is not an internal portion of the building.

The waveguide of the present invention can also have third and fourth antennas electrically connected together, thus forming a second waveguide. At least one of the first, second, third, and/or fourth antennas can have a wide bandwidth, and any or all of these antennas can be a discone antenna. The third antenna can be disposed in an inner portion of a building. The fourth antenna can be disposed near an outer portion of a building, on an outer portion of a building, and/or outside of a building. The third antenna can be disposed within an internal portion of a building while the fourth antenna is simultaneously not disposed in an internal portion of the building. The first and third antennas can be disposed within an internal portion of a building and the second and said fourth antennas can simultaneously not be disposed in an internal portion of the building. Finally, the third and/or fourth antennas can be an assembly of more than one antenna.

The present invention also relates to a method for improving transmission and/or reception of devices which communicate via electromagnetic waves. The method can include disposing a first antenna in a first area, the first area being an area where electromagnetic wave transmission and/or reception is desired to be improved; disposing a second antenna in second area where transmission and/or reception capabilities are better than said first area; and connecting the first and second antennas with an electrical conductor. The first and/or second antenna can have an array of antennas used in its place. Any and/or all of the antennas used can have a wide bandwidth, and any and/or all of the antennas can be discone antennas. The first area can be an area within a building or other structure, and the second area can be a non-internal portion of a building.

The method of the present invention can also include providing a third and fourth antenna electrically connected to one another. The third antenna can be disposed in the first area, and the fourth antenna can be disposed in the second area. Any and/or all of the antennas can have a wide bandwidth, and any and/or all of the antennas can be discone antennas.

The present invention also relates to an apparatus having two cones, each cone having an apex and a base; two discs, each disc disposed adjacent the apex of a respective cone; and an electrical conductor, at least partially disposed inside of the cones, such that the conductor electrically connects the discs.

The present invention also relates to an apparatus having a plurality of antennas, each antenna comprising a cone with an apex and a base, a disc disposed near the apex of the cone, and an electrically conductive cable which is in electrical contact with the disc. The conductors of the antennas can be connected electrically in series. Optionally, at least a portion of at least one cable can be disposed within at least one of the cones.

A primary advantage of the present invention is that methods and apparatus are provided which improve transmission and/or reception of electromagnetic waves to such a degree that wireless signals can be used in areas where such use was previously prohibited.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention In the drawings:

FIG. 1 is a perspective view showing a preferred embodiment of the present invention where a discone-type antenna is used as a waveguide for a cellular phone on the 44^{th} floor of a skyscraper building;

FIG. 1-2 is a ground plan of the 44^{th} floor of the skyscraper building depicted in FIG. 1;

FIG. 2 is a perspective view showing an embodiment of the present invention wherein a plurality of waveguides are used for improving cellular phone communication in an inner bathroom of a condominium;

FIG. 3-1 is a graph showing measured signal levels for a cellular phone in a room of a hotel, far from a base station, without the use of the present invention;

FIG. 3-2 is a graph showing measured signal levels for a cellular phone in a room of a hotel, far from a base station, where the present invention was used;

FIG. 4 is a floor layout of an office room where the present invention was used as an exterior antenna for a wireless LAN card;

FIG. 5-1 is a graph showing measurements for a wireless LAN card without an external antenna;

FIG. 5-2 is a graph showing measurements for a wireless LAN card wherein an external whip antenna is used;

FIG. 5-3 is a graph showing measurements for a wireless LAN card wherein an external discone-type antenna of the present invention is used;

FIG. 6-1 is a cross-sectional view of a discone-type antenna;

FIG. 6-2 is a schematic view of a discone-type antenna showing designing parameters;

FIGS. 7-1 to 8 are schematic drawings showing various configurations of discone-type antenna arrays;

FIGS. 9-17 are schematic drawings depicting alternative embodiments of discone antennas that may be used in the present invention;

FIGS. 18-23 are schematic drawings depicting flat discone antennas that may be used in the present invention; and

FIGS. 24-26 are schematic drawings depicting alternative embodiments wherein a plurality of cones are simultaneously used.

### DETAILED DESCRIPTION OF THE INVENTION

The present invention is directed to antennas, particularly to those having broadband capabilities, which can be used to improve the Transmit and/or Receive (T/R) efficiency of cellular phones, wireless LANs, and other communication systems. The present invention preferably achieves its objectives with the aid of one or more discone-type antenna. The one or more antenna are preferably connected as external antennas or as one or more waveguides.

The term “waveguide” as used throughout the specification is used to refer to a construction wherein a first antenna or assembly thereof is disposed at a terminal end of a conductor and a second antenna or assembly thereof is disposed at the proximal end of a conductor. Although the waveguide of the present invention can operate when the entire waveguide is within a small area, more desirable results are obtained when the waveguide of the present invention is stretched such that the first and second antennas are in remotely-separate areas.

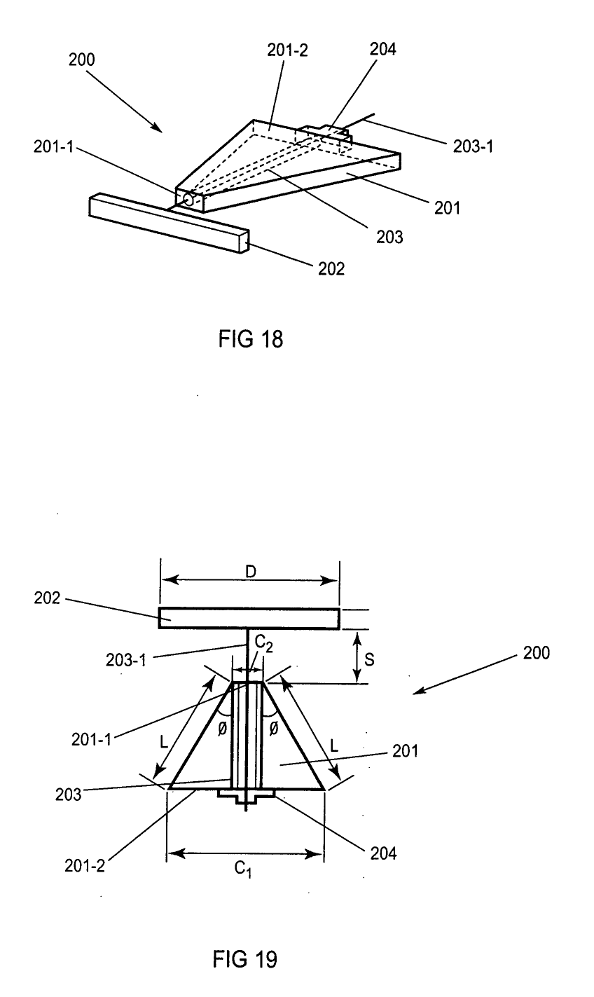

The terms “discone antenna”, “disc-cone antenna”, and “discone-type antenna” are intended to mean an antenna, having disc and cone components, and those antennas where a triangular or trapezoidal or similar shaped grounded element is disposed near an electromagnetic wave emitting or receiving element such as those depicted, for example, in FIGS. 18-24. It is preferable that the discone-type antenna use a cable, such as coaxial cable. The discone antenna of the present invention can also have an insulator as well as a reflector. In order to obtain desirable results in large spaces or inner recesses, one embodiment of the present invention may comprise four or more antennas, which are preferably discone antennas, used to create a plurality of waveguides. The present invention can also produce desirable results by using just two antennas, which are preferably discone-type antennas, to produce a single waveguide.

The term “building” as used throughout the specifications and claims is used for the sake of simplicity and is intended to include any type of building, structure, tunnel, vehicle, vessel, or the like.

The following is a description of the basic structure and operating characteristics of a discone-type antenna relying on J. J. Nail's Designing Discone antennas, Electronics, August 1953, pp 167-169.

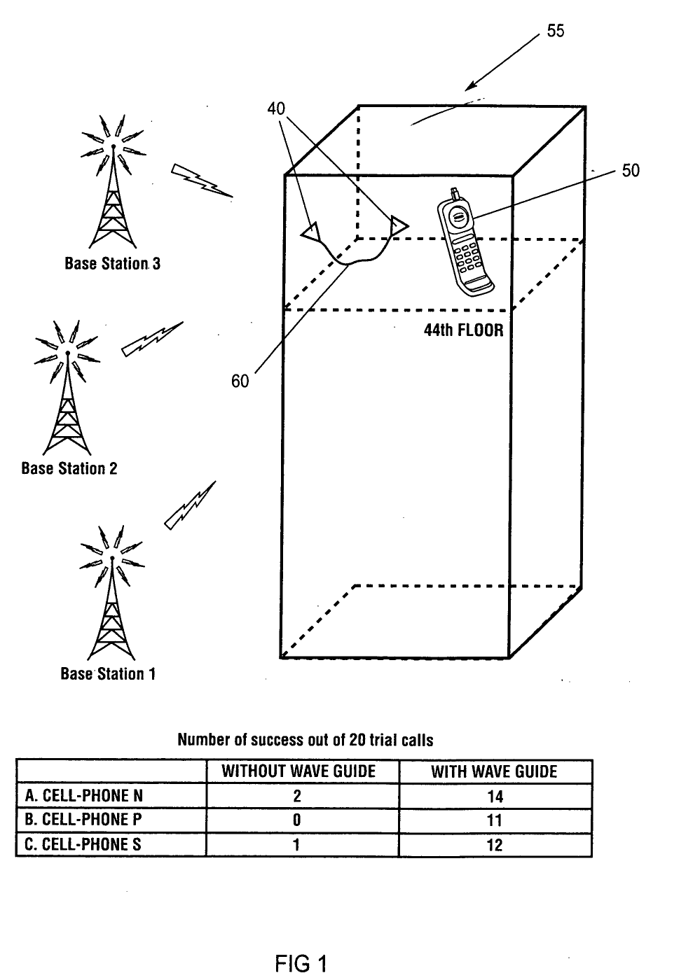

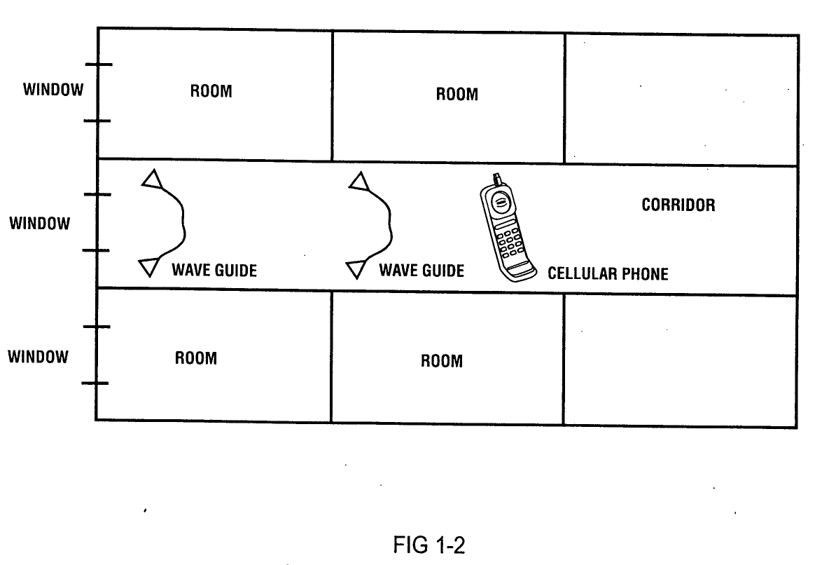

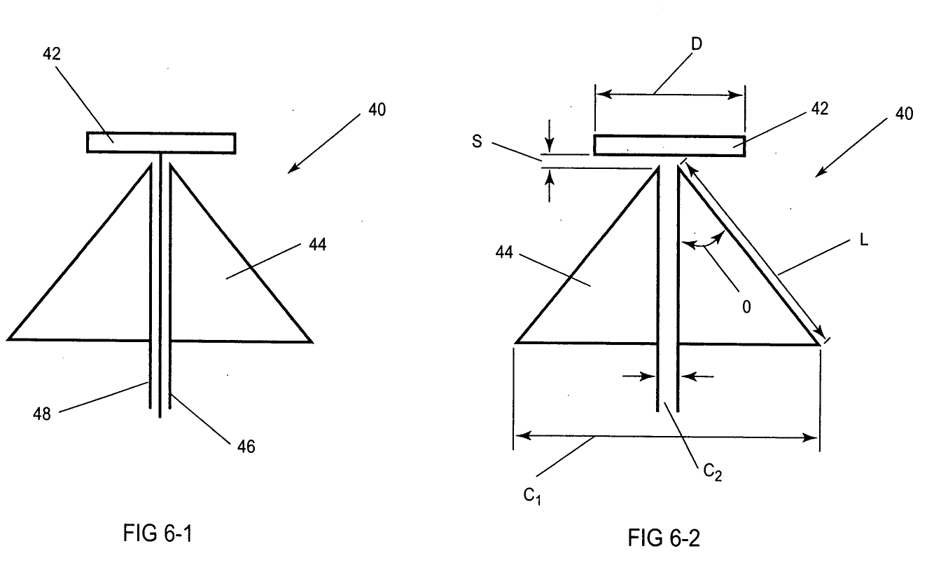

The schematic cross section view of discone antenna 40, of the present invention, is shown in FIG. 6-1. Discone antenna 40 comprises disk 42, cone 44, feeding cable 46 and central conductor 48 of feeding cable 46. Electric power is fed to disk 42 through central conductor 48 of feeding cable 46. Cone 44 is typically grounded.

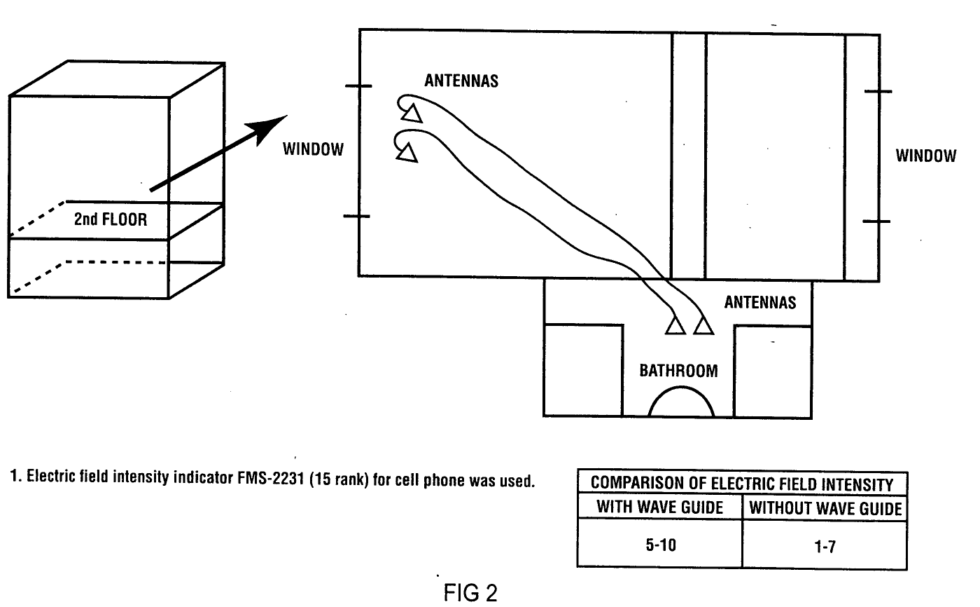

The design parameters of a discone antenna are shown in FIG. 6-2. C1 is the maximum diameter of cone 44. C2 is the minimum diameter of cone 44. L is the slant height of cone 44. φ is the flare angle of cone 44. S is the disk-to-cone spacing. D is the diameter of disk 42.

The bandwidth of a discone antenna can be determined based on its Standing Wave Ratio (SWR); frequencies for which the SWR is less than two define the bandwidth of the antenna. The lowest frequency of the discone's bandwidth has a wavelength of approximately four times the slant height of the cone.

Using a cone flare angle (φ) of 60 degrees can result, according to Nail, in a discone antenna with a bandwidth from 400-1300 MHz or more. It is possible to reduce the minimum frequency of the bandwidth by increasing diameter C1 of cone 44. Decreasing space S between disk 42 and cone 44 can increase the maximum frequency of the bandwidth.

FIG. 1 shows a preferred embodiment wherein the present invention is used as a waveguide for cellular phone 50 on the 44^{th} floor of skyscraper 55 where communication by cellular phone 50 is not possible due to electromagnetic wave interference from multiple cellular base stations. A pair of discone antennas 40 is preferably connected with coaxial cable 60, and disposed on a window shelf. Another pair of discone antennas 40, also preferably connected with coaxial cable 60, is disposed in an interior section of skyscraper 55. It is preferable that antennas 40, disposed on the window shelf, be separated by a distance of about one-half of a wavelength of the operating frequency of cellular phone 50. The waveguide of the present invention does not need any power or energy for operation.

FIG. 2 shows an embodiment of the present invention comprising a waveguide for cellular phone 50 in an inner bathroom of a condominium where the electromagnetic signal level from a base station is weak.

A pair of discone antennas 40 is preferably disposed on a shelf near the window and another pair is preferably disposed in an inner portion of the condominium. One discone antenna 40, disposed near a window, is preferably connected to another discone antenna 40, disposed in an inner portion of the condominium, with coaxial cable 60. The remaining pair of discone antennas 40 are preferably connected in a similar manner. Thus, the strong electromagnetic signal near the window is distributed through the waveguide of the present invention to an inner portion of the condominium, where the electromagnetic signal is weak.

The present invention produces desirable results for radio communication systems, cellular phones, and wireless LANs. Particularly desirable results can be achieved with 800 MHz to 2.4 GHz band frequencies as well as systems which utilize the broadband characteristic of a discone antenna.

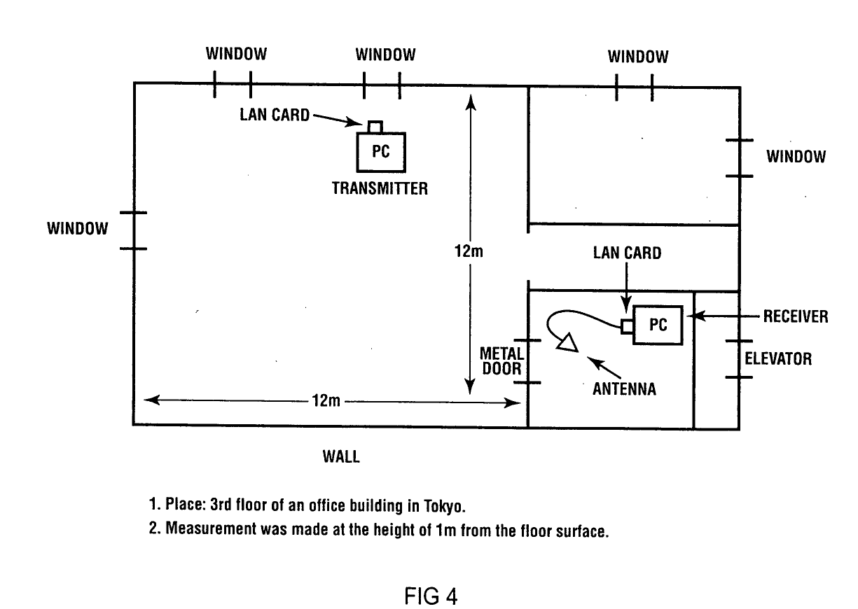

In another embodiment, the present invention can be used as an exterior antenna for wireless LAN cards in offices, as depicted in FIG. 4. It is preferable that a receiver of a wireless LAN card be connected to a discone antenna 40, which is attached as an exterior antenna.

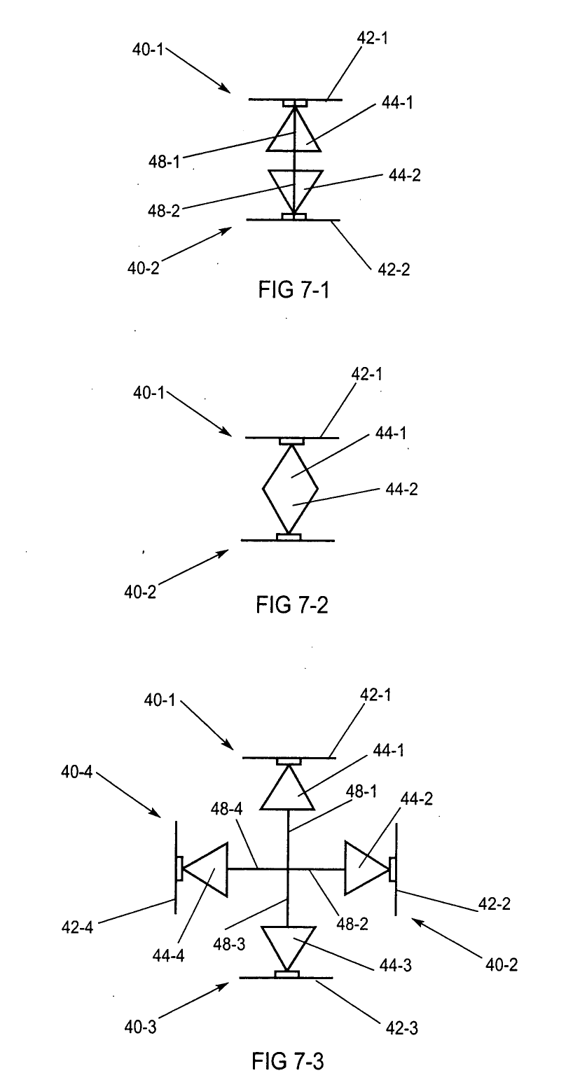

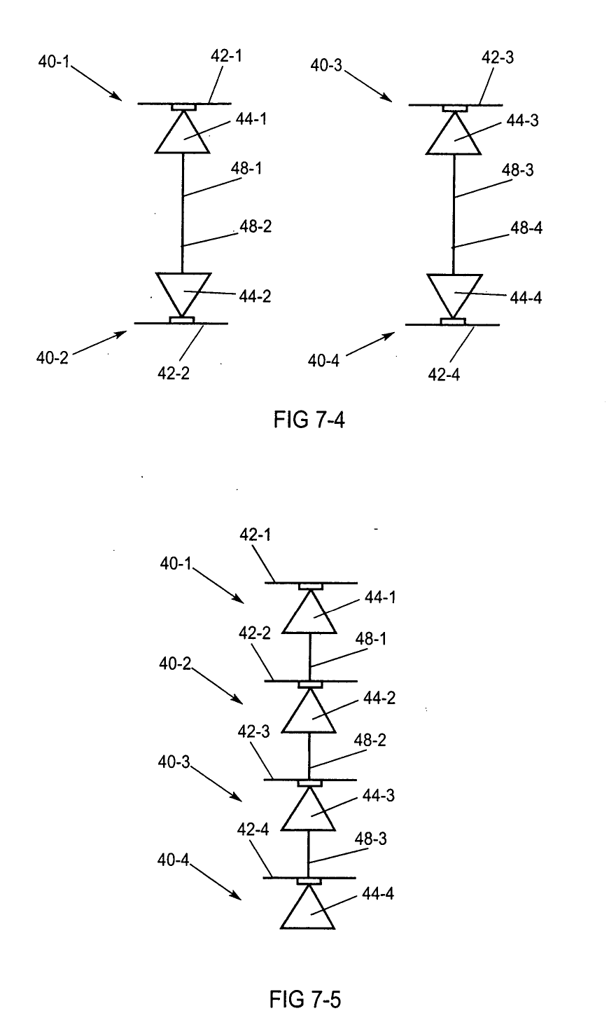

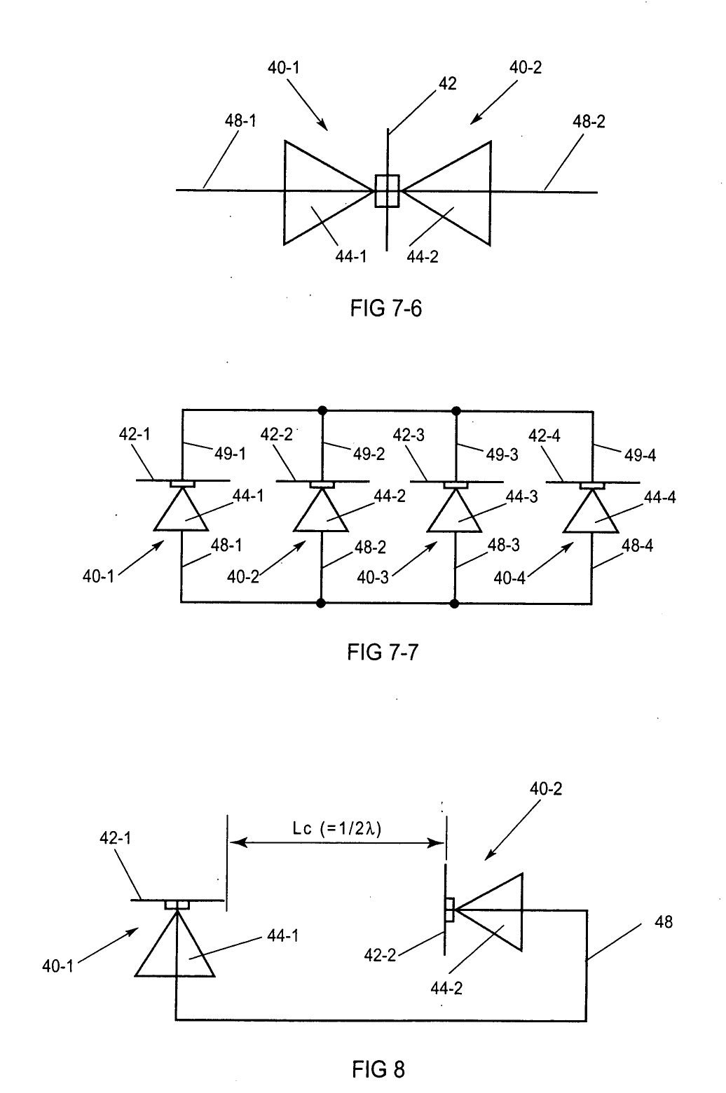

FIGS. 7-1, through 7-5 show alternative configurations for discone antennas of the present invention.

The design parameters C₁, C₂, L, φ, S, and D for antenna apparatus according to several embodiments of the present invention are preferably determined by the following equations:
S, the spacing between the disc and cone, is preferably determined by S=0.3×C₂ Equation 1
D, the diameter of the disc, is preferably determined by D=0.7×C₁ Equation 2
φ, the cone angle, is preferably determined by φ=60° Equation 3

As previously indicated, the bandwidth of an antenna is evaluated with respect to its SWR (Standing Wave Ratio). The bandwidth of an antenna is the range wherein the SWR is less than 2. The minimum frequency of this bandwidth corresponds to a wavelength which is equivalent to four times the length of the cone slant (L). The minimum diameter C₂ of the cone is inversely proportional to the frequency bandwidth, and is determined based on a desired maximum frequency. The cone angle φ determines SWR frequency characteristics. Although the optimal value of φ will depend on the specific application, it is often preferable for φ to have a value between 40° and 70°, and most preferably about 60°.

Although the non-insulative elements of discone-type antennas can be manufactured from virtually any type of material or element capable of at least partially conducting electricity, the material used for the non-insulative elements of discone-type antennas of the present invention preferably comprises one or more of the following: gold, copper, aluminum, stainless steel, brass, combinations of these, and the like. The inside of the disc and/or the cone of a discone-type antenna may be hollow or filled. The filling can include any type of material including the conductive material from which the antenna itself is made.

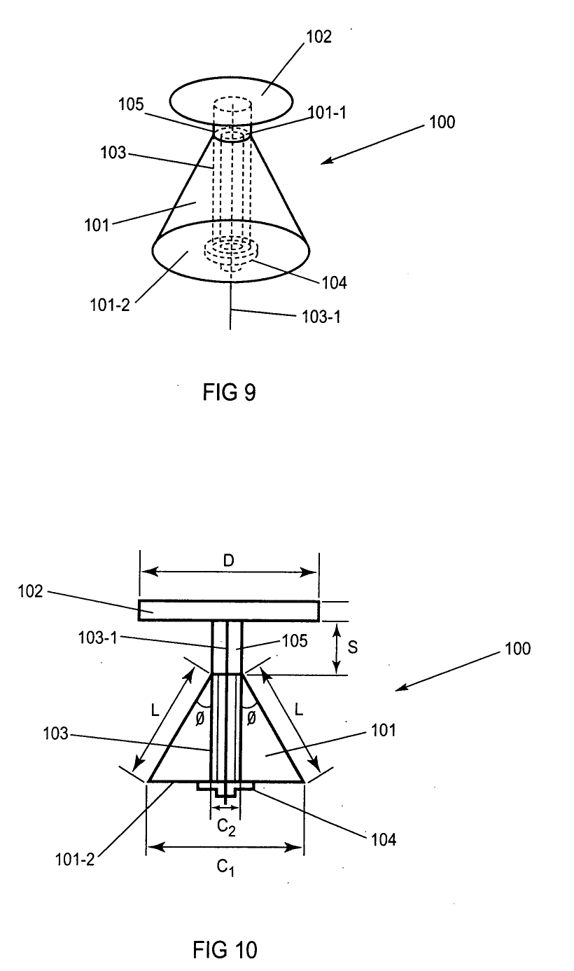

As depicted in FIGS. 9-17, the discone-type antenna 100 of an embodiment of the present invention realizes high gain over a broadband compared to a conventional discone-type antenna.

The antenna apparatus of the present invention is usable in office buildings, hospitals, factories, stadiums, tunnels, trains, automobiles, aircrafts, ships and other structures, stations, and vehicles. The antenna apparatus of the present invention is also usable as an antenna for a Personal Hand Set (PHS) relay station.

### INDUSTRIAL APPLICABILITY

The invention is further illustrated by the following non-limiting examples. The various elements of the following examples can be interchanged and desirable results can still be produced. As such, the following examples are intended to depict several possible configurations useful for the present invention, but do not constitute every possible combination.

### EXAMPLE 1

Referring to FIG. 1, typically cellular phone performance degrades significantly for floors greater than the 20^{th} floor in large buildings. This is due to the electromagnetic wave interference from multiple base stations which is typically encountered when using cellular phones that are equipped only with a whip antenna or a built-in pattern antenna. To study the effect of the present invention used as a wave guide for cellular phones, an experiment on the 44^{th} floor of a skyscraper building was conducted. Twenty trial calls were made for each of three different types of cellular phones without the use of the present invention. The number of successful calls placed was recorded.

A pair of discone antennas was then placed on a shelf near a window and another pair of discone antennas were placed on a table in an inner portion of a building. They were connected as depicted in FIGS. 1-2, thus producing a waveguide. After setting up the waveguide of the present invention, 20 trial calls were made for each of the three different types of cellular phones. The number of successful calls placed was recorded. A significant improvement in number of successful calls placed was observed when the present invention was used. Referring to the chart at the bottom of FIG. 1, it can be observed that of the sixty calls placed without the use of the present invention, only three were successful. Using the waveguide of the present invention increased the number of successfully placed calls from a mere three to some 37, a staggering 1,133% increase in the number of successfully completed calls. Based on the results of this experiment, it was found that successful cellular phone communication can be possible in upper floors of skyscrapers when the present invention is used

### EXAMPLE 2

Referring to FIG. 2, discone antennas were used to create a waveguide for cellular phones in an inner bathroom of a condominium. Typically, calls cannot be placed from the particular bathroom used in this experiment. This is because the electromagnetic signal from the cellular base station is too weak. A first pair of discone antennas was disposed near a window and a second pair of discone antennas was disposed in an inner bathroom of the condominium. One of the antennas in the bathroom was connected to one of the antennas near the window, and the remaining two antennas were also connected to one another, thus producing a waveguide. At the window, where the first pair of discone antennas were disposed, the electromagnetic signal level is rather high. However, in the inner bathroom, where the other two discone antennas are disposed, the electromagnetic signal is weak.

The magnitude of the electromagnetic signals, with and without the use of the present invention, was measured in the inner bathroom with a signal level measuring instrument. The measurements were compared, thus resulting in the observation of a significant improvement in magnitude of the electromagnetic signals in the inner bathroom, caused by the present invention.

It was thus found that the present invention enables successful cellular telephone communication while in the inner recesses of a building where cellular phone communication was previously not possible. The present invention achieves this without the need for an additional source of power.

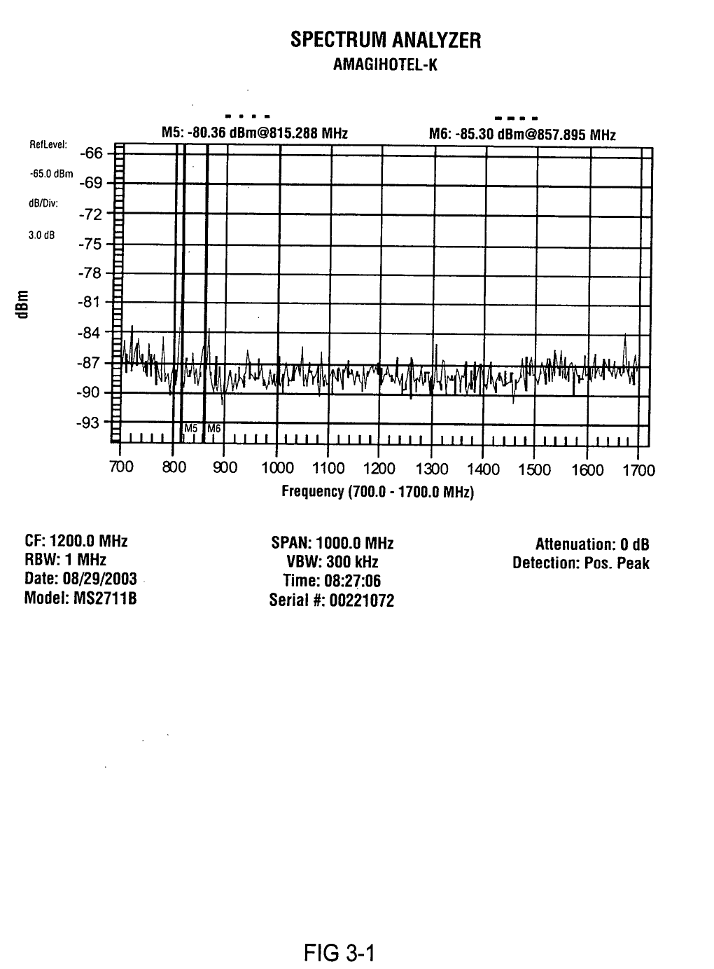

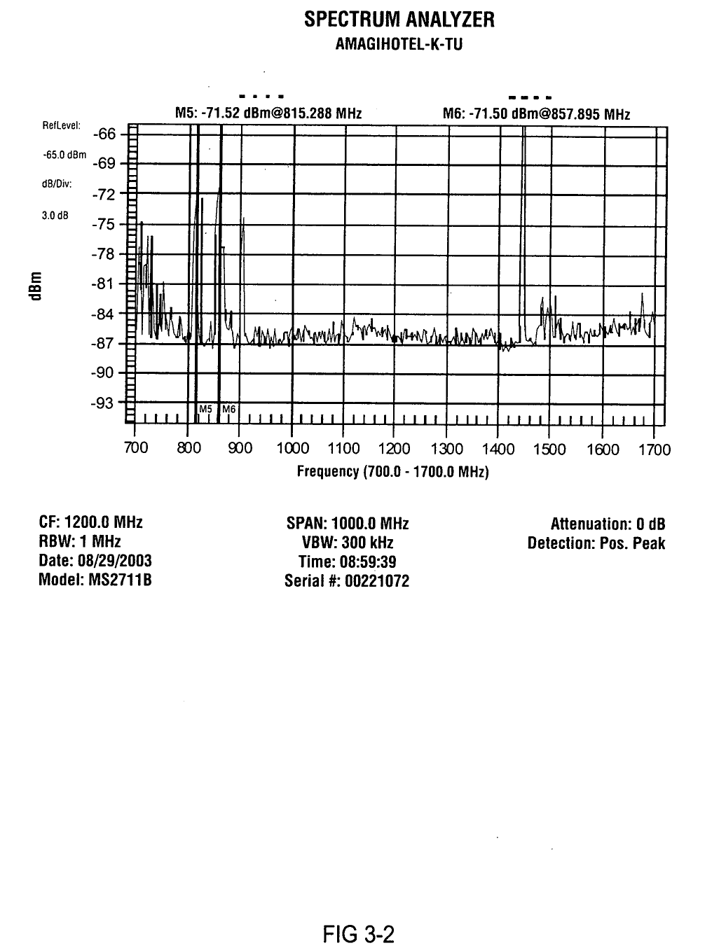

Similar experiments were conducted in inner recesses of other large buildings. These experiments also resulted in the finding that the present invention enables efficient communication with cellular phones in inner recesses of buildings which are far from base stations. FIG. 3-1, for example, shows measurements obtained from a spectrum analyzer in an inner portion of the building where the present invention was not used. FIG. 3-2 shows measurements obtained from a spectrum analyzer in the same inner portion of the building, this time employing the use of the waveguide of the present invention.

### EXAMPLE 3

FIG. 4 depicts a schematic view of the setup used in this experiment. As shown therein, a discone antenna was connected as an exterior antenna to wireless LAN card in an office room. A transmitter with wireless LAN card was placed near the wall in the office room, while a receiver with wireless LAN card was positioned in front of an elevator separated by a metal door, which resided in an inner portion of a building where previous use of wireless LAN cards resulted in poor performance due to the low Signal to Noise (S/N) ratio. By using the discone antenna as an exterior antenna outside of the metal door, a significant improvement in the signal level, S/N ratio, and the transmission speed was detected. The present invention thus enables LAN cards to be used in an economic and efficient manner.

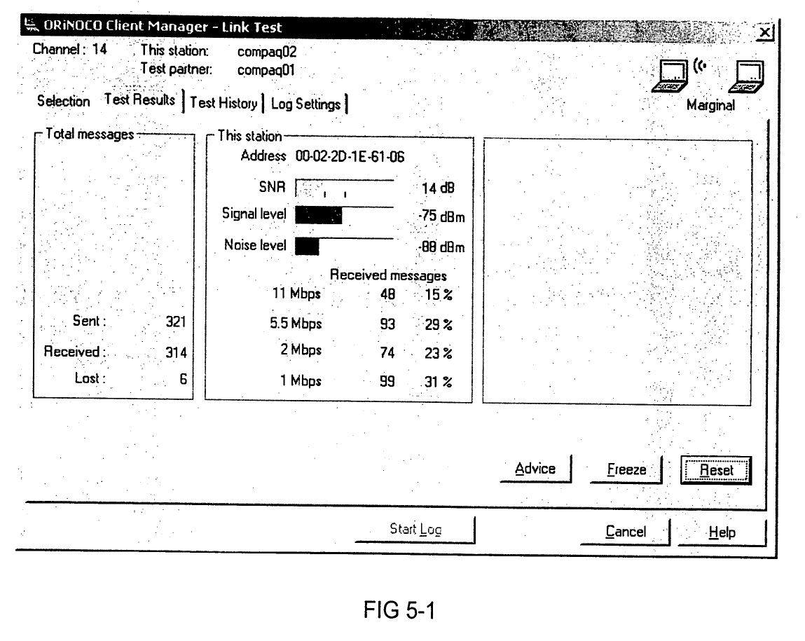

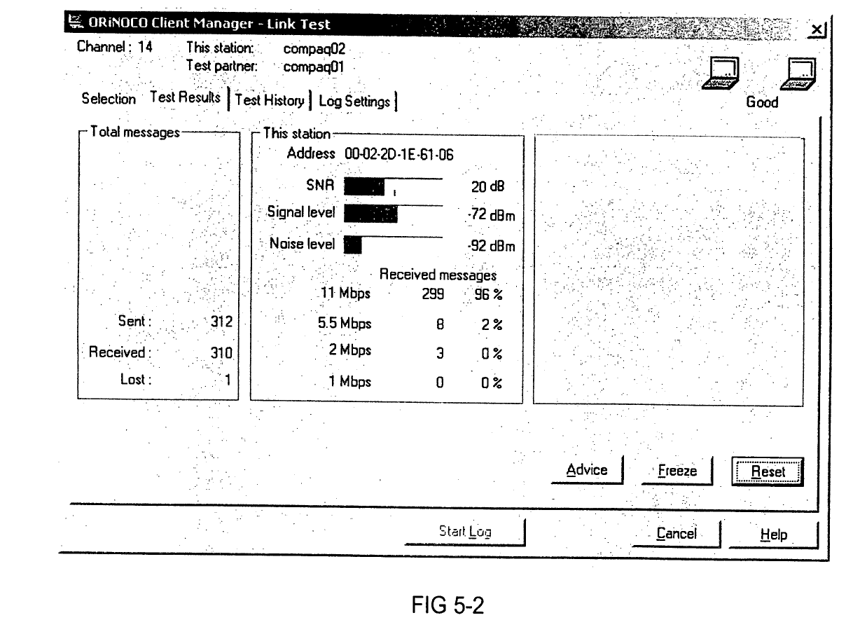

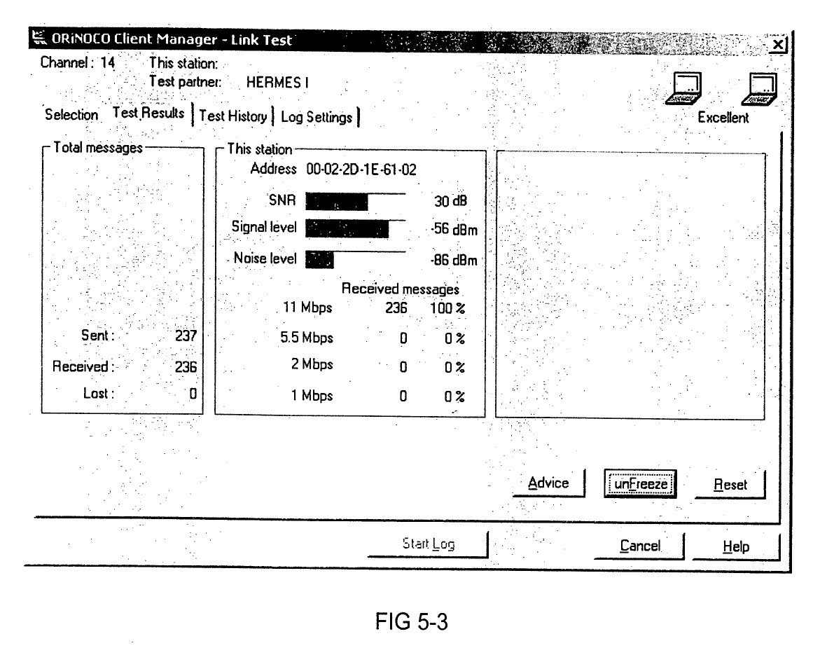

FIGS. 5-1, 5-2, and 5-3 show measurements of signal level and S/N ratio for instances where an external whip antenna (FIG. 5-2), an external discone antenna (FIG. 5-3), and no external antenna (FIG. 5-1) were used in conjunction with a wireless LAN receiver card. As shown in the figures, a significant improvement in signal level, SIN ratio, and transmission speed was noted where the discone antenna was attached. Based on these measurements, it is apparent that the discone antenna provides results which are superior to the external whip antenna as well as the wireless LAN card where no external antenna was used.

### EXAMPLE 4

Other examples of antennas with which the present invention produces desirable results are depicted in FIGS. 7-1 to 7-7. FIG. 7-1 shows an alternative embodiment of the present invention. As depicted therein, two antennas 40-1 and 40-2 are combined into an assembly. The center conductors of cables 48-1 and 48-2 extend from the base of cones 44-1 and 44-2 of two antennas 40-1 and 40-2 and are connected electrically. The center conductors of cables 48-1 and 48-2 penetrate cones 44-1 and 44-2 and are extended to discs 42-1 and 42-2 and connected to them electrically. As such, the center conductors of cables 48-1 and 48-2 are partially disposed within cones 44-1 and 44-2. The outer conductor is not extending into either cone, but it electrically connects the bases of the cones. Although not required, conductors of cables 48-1 and 48-2 can comprise a single continuous conductor.

### EXAMPLE 5

In the antenna assembly, shown in FIG. 7-2, the bases of cones 44-1 and 44-2 of antennas 40-1 and 40-2 contact one another physically thus, connecting them electrically. The center conductors of feeding cable shown in other Figures preferably penetrate cones 44-1 and 44-2 and the center conductors extend and are electrically connected to discs 42-1 and 42-2. As such, the center conductors are completely disposed within cones 44-1 and 44-2. Since the bases of the cones are touching one another, the outer conductors of cables are not used.

### EXAMPLE 6

The assembly of antennas configuration shown in FIG. 7-3 is created by combining four antennas 40-1, 40-2, 40-3, and 40-4. The discs 42-1, 42-2, 42-3 and 42-4 are preferably oriented to the outside of the configuration, and the cones 44-1, 44-2, 44-3 and 44-4 are preferably oriented to the inside of the configuration. Center conductors of cables 48-1, 48-2, 48-3 and 48-4 of antennas 40-1 to 40-4 are connected to each other. The center conductors of cables 48-1 to 48-4 penetrate cones 44-1 to 44-4 and the center conductors of cables 48-1 to 48-4 are extended until they are connected electrically to discs 42-1 to 42-4. The outer conductors do not extend to an interior portion of cones 44-1 to 44-4 but rather, are connected to the base of the cones.

FIG. 7-3 shows an embodiment of an antenna assembly of the present invention wherein four antennas 40-1 to 40-4 are configured and connected to one another. Alternatively, only two antennas 40-1 and 40-2 can be connected with 90 rotation to each other instead. In this case, feeding cables 48-1 and 48-2, having a center conductor, preferably penetrate two cones 44-1 and 44-2, and the center conductor is preferably extended until it is connected electrically to discs 42-1 and 42-2. The outer conductors need not penetrate each cone but rather may be connected electrically to the base of each cone.

### EXAMPLE 7

FIG. 7-4 shows an antenna assembly in which a pair of the antenna apparatuses shown in FIG. 7-1 is used. The feeding cable with center conductor penetrates cones 44-1 and 44-2 and the center conductors of cables 48-1 and 48-2 is connected electrically to discs 42-1 and 42-2. The outer conductors of cables 48-1 and 48-2 can penetrate cones 44-1 and 44-2, but instead cables 48-1 and 48-2 are preferably connected electrically to the base of cones 44-1 and 44-2.

### EXAMPLE 8

FIG. 7-5 shows an antenna assembly in which four antennas 40-1, 40-2, 40-3 and 40-4 are connected in series. Antenna 40-1 is preferably connected to disc 42-2 of antenna 40-2 to which the center conductor of cable 48-1, extends from the base of cone 44-1. Disc 42-3 is preferably connected to cone 44-2 and disc 42-4 is preferably connected to cone 44-3. Any number of antennas can be placed in series in this manner, and the present invention is not limited to only four antennas.

The center conductors of feeding cables 48-1, 48-2, 48-3 and 48-4 preferably penetrate cones 44-1, 44-2, 44-3 and 44-4, and the center conductors of cables 48-1 to 48-4 preferably extended and electrically connected to discs 42-1, 42-2, 42-3 and 42-4. The center conductors of cables 48-1 to 48-4 need not penetrate cones 44-1 to 44-4 but rather can be connected to discs 42-1 to 42-4, adjacent to the base of each cone.

### EXAMPLE 9

FIG. 7-6 shows an embodiment of the present invention wherein an assembly of two antennas 40-1 and 40-2 are connected in such a manner that each disc 42 of the two antennas 40-1 and 40-2 is oriented to the inside of the configuration and the base of cones 44-1 and 44-2 are oriented to the outside. Two antennas thus share a single disc 42. Feeding cables 48-1 and 48-2 with a center conductor preferably penetrates cones 44-1 and 44-2 and their center conductors 48-1 and 48-2 are connected electrically to disc 42. The outer conductor of cables 48-1 and 48-2 preferably do not penetrate cones 44-1 and 44-2 but are connected electrically to the base of cones 44-1 and 44-2.

### EXAMPLE 10

FIG. 7-7 shows the configuration of another embodiment of the present invention wherein an assembly of four antennas 40-1, 40-2, 40-3 and 40-4 are connected in parallel. The outer conductors of cables 48-1, 48-2, 48-3 and 48-4 extend form the base of cones 40-1, 40-2, 40-3 and 40-4 of antennas 40-1, 40-2, 40-3 and 40-4 and are connected to each other. The center conductors of cables 49-1, 49-2, 49-3 and 49-4 are connected to discs 42-1, 42-2, 42-3 and 42-4 of antennas 40-1, 40-2, 40-3 and 40-4.

The antenna apparatus of this example can realize a wide bandwidth and high gains. It also reduces the noise level, thus improving the S/N ratio. Although four antennas are depicted in FIG. 7-7, the present invention is not limited to only four antennas connected in this configuration. The connection of alternative numbers of antennas in parallel also provides desirable results.

### EXAMPLE 11

An alternative embodiment of an antenna assembly of the present invention is depicted in FIG. 8. As depicted therein, two antennas 40 (40-1 and 40-2) of the present invention are connected with the center conductor 48. Antenna 40-1 and antenna 40-2 are positioned such that they have a 90° rotation with respect to one another. Thus, the extension line from disc 42-1 and that of disc 42-2 are orthogonal to one another. The distance Lc from the edge of disc 42-1 of antenna 40-1 to disc 42-2 of antenna 44-2 is preferably one-half a wavelength of the operating frequency. Center conductor 48 preferably penetrates cones 44-1 and 44-2 and preferably extends to discs 42-1 and 42-2, thus electrically connecting them. As such, center conductor 48 is routed through an interior of cones 44-1 and 44-2. In this embodiment, an outer conductor of cable 48 does not extend to within each cone but does connect to the bases of the cones together, thus electrically connecting them.

The antenna apparatus of this embodiment realizes wide bandwidth and high gain. It also reduces the noise level, therefore improving the S/N ratio.

### EXAMPLE 12

FIGS. 9 and 10 depict alternative variations of antennas 40 used for the antenna apparatus of the present invention.

FIG. 9 shows a perspective view of discone-type antenna 100 used for the antenna apparatus and FIG. 10 shows a cross sectional view of discone-type antenna 100. Discone-type antenna 100 comprises cone 101, disc 102, feeding cable 103, and insulator 105. Cone 101 comprises apex 101-1 and base 101-2. Feeding cable 103 has center conductor 103-1 covered with an insulated layer. Disc 102 is preferably disposed over apex 101-1 and insulator 105 is preferably disposed between disc 102 and apex 101-1. Feeding cable 103 preferably penetrates the inside of cone 101. Center conductor 103-1 of feeding cable 103 preferably travels through the outside of cone 101 and extends to and connects electrically to disc 102.

In this example, the coaxial cable is used as feeding cable 103 and the center conductor in coaxial cable corresponds to center conductor 103-1. The shield wire, which encompasses the center conductor of coaxial cable, is preferably connected to terminal 104, which is connected electrically to base 101-2 of cone 101. Center conductor 103-1 is preferably insulated from and is not connected electrically to cone 101.

The design parameters for discone antenna 100 in this example are preferably defined as follows:
the diameter of the base 101-2 of cone 101 (maximum diameter of cone101): C₁;
the diameter of apex 101-1 (minimum diameter of cone 101): C₂;
the length of cone slant: L;
the cone angle: φ;
the diameter of disc 102: D; and
the distance between disc 102 and cone 101: S.

By adjusting the parameters of C₁, C₂, L, φ, S and D, Equations 1, 2, and 3, can be satisfied such that the present invention produces particularly desirable results.

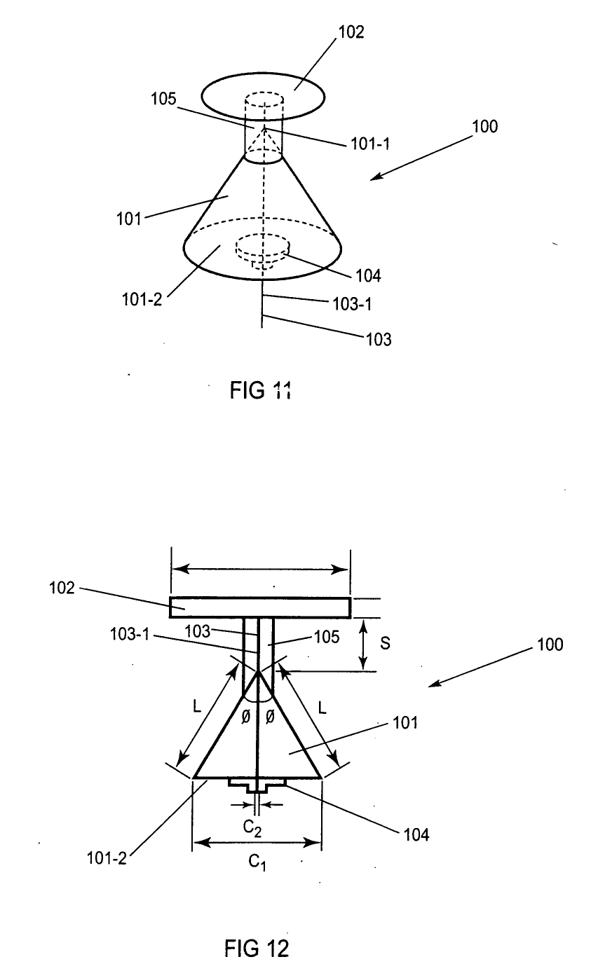

Coaxial cable is preferably used as feeding cable 103 in this example. A simple structure of cable 103, which is preferably covered with an insulative layer, may be used and center conductor 103-1 is preferably insulated from and not connected electrically to cone 101. FIG. 12 shows a cross sectional view of antenna 110 of FIG. 11. As shown in FIG. 12, the diameter of apex 100-1, which is preferably a minimum diameter of cone 101, is similarly defined as C₂.

Insulator 105 is preferably used in order to keep the distance constant between cone 101 and disc 102, but insulator 105 is not required, particularly when the distance between cone 101 and disc 102 can be kept constant without it.

Antenna apparatus 100 of this example realizes wide bandwidth and high gains. It also reduces noise level, thus improving the S/N ratio.

### EXAMPLE 13

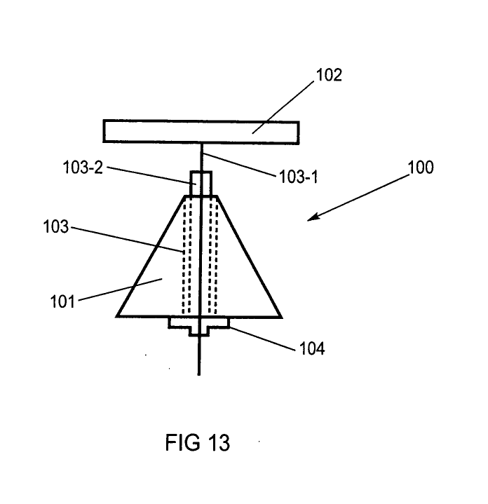

FIG. 13 depicts another alternative embodiment of the antenna of the present invention. As depicted therein, a perspective view of discone-type antenna 100 is shown. Components of antenna 100 which are similar to those depicted in FIGS. 9 and 11 are not explained here since previous discussions of those components is equally applicable here. Insulator 103-2 is the inside insulator of feeding cable 103 (coaxial cable in this example), and is used for insulating the center conductor 103-1 from the outside shield wire.

FIG. 13 shows that the inside insulator 103-2 of feeding cable 103 protrudes from cone 103 and is extended to an outside of cone 101. The partly naked center conductor 103-1 of the feeding cable is extended and connected electrically to disc 102. The portion of center conductor 103-1 of feeding cable 103 which is extended beyond the shielding wire is preferably covered with an insulative material.

The antenna apparatus of this example realizes a wide bandwidth and high gains. It also reduces noise, thus improving the S/N ratio.

### EXAMPLE 14

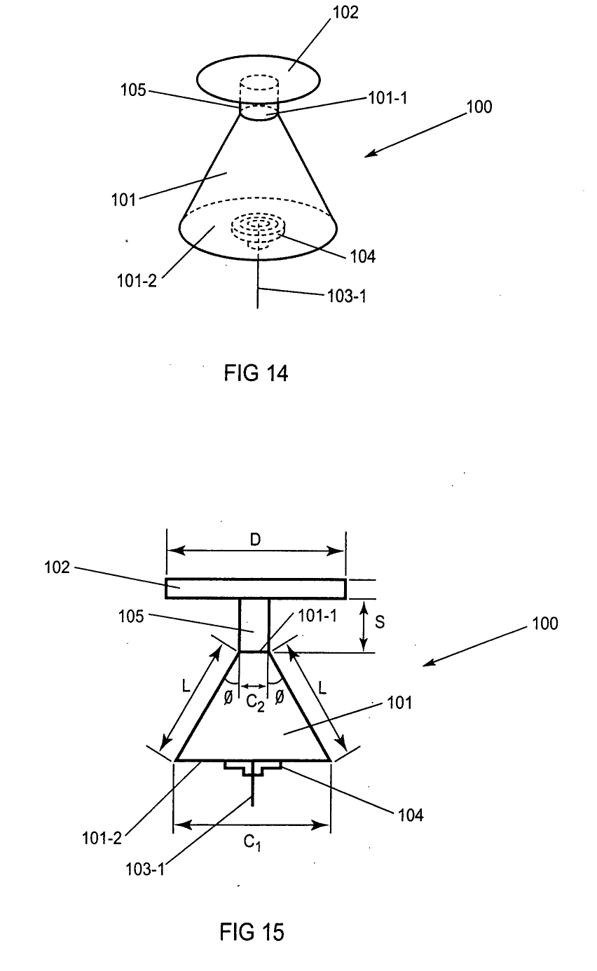

FIGS. 14 and 15 show variations of an antenna which can be used and will produce desirable results in conjunction with the present invention. Components of antenna 100 which are similar to those depicted in FIGS. 9 and 11 are not explained here since previous discussions of those components is equally applicable here. FIG. 14 shows that antenna 100 preferably has no feeding cable in cone 101 and center conductor 103-1 is connected electrically to base 101-2 of the cone 101. Center conductor 103-1 is preferably not connected electrically to disc 102. Moreover, center conductor 103-1 is preferably not connected electrically to disc 102.

FIG. 15 shows the cross sectional view of the antenna 100 shown in FIG. 14, and shows the design parameters for antenna 100 used in this example. All the parameters are preferably determined such that they satisfy Equations 1, 2, and 3.

Insulator 105 is preferably used to keep the distance fixed between cone 101 and disc 102 in this example. However, insulator 105 is preferably not used when the distance can be kept fixed without using insulator 105.

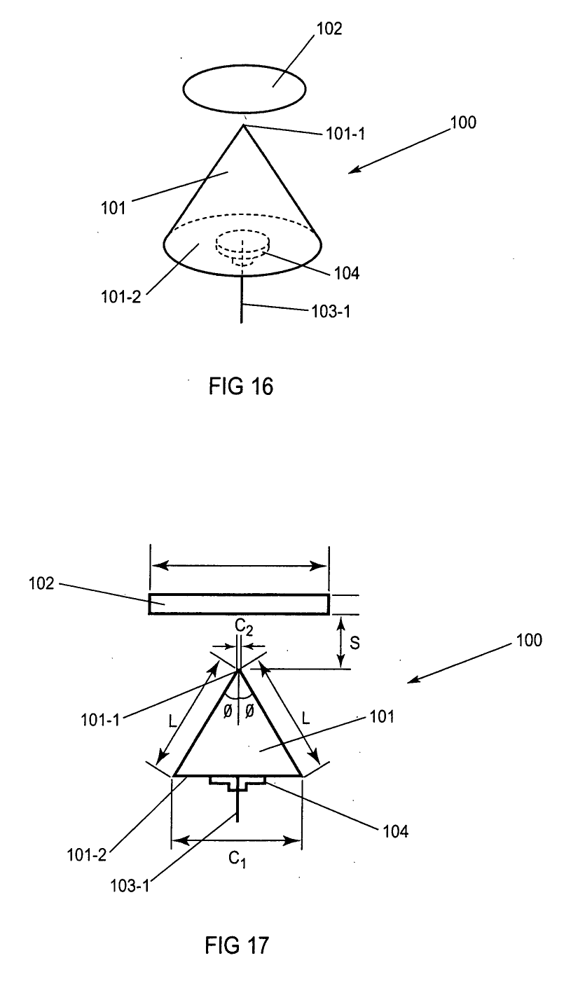

FIG. 16 shows cone 101, apex 101-1 of which is depicted as coming to a point. FIG. 17 shows a cross sectional view of the antenna shown in FIG. 16. The diameter of apex 101-1 (preferably the minimum diameter of cone 101) is defined as C₂.

The antenna apparatus 100 of this example realizes a wide bandwidth and high gains. It also reduce the noise level, thus improving the S/N ratio.

### EXAMPLE 15

FIGS. 18 and 19 show variations of an antenna which can be used with and will produce desirable results in conjunction with the antenna apparatus of the present invention.

The antennas in this example are flattered versions (hereinafter referred to as “flat antenna”) of the antennas 100 shown in FIGS. 9 to 17.

FIG. 18 shows a perspective view of flat antenna 200. Flat antenna 200 preferably has a shape similar to a cross sectional view of the antenna depicted FIG. 11. Flat antenna 200 thus preferably has trapezoidal component 201 with a thickness and bar component 202, disposed near and parallel with upper base 201-1 of trapezoidal component 201. Trapezoidal component 201 has feeding cable 203, preferably a coaxial cable, disposed within. Trapezoidal component 201 also preferably has center conductor 203-1 of the feeding cable 203 preferably penetrate it which is extended to bar component 202 and connected electrically thereto.

In this example, the twist wires (shield wires) which preferably encompass center conductor 203-1 are preferably connected to terminal 204 which are preferably connected to lower base 201-2 of trapezoidal component 201. Center conductor 203-1 is preferably insulated from trapezoidal component 201.

FIG. 18 shows that the insulator of cable 203 preferably does not penetrate trapezoidal component 201. However, the insulator of cable 203 may penetrate the trapezoidal component 201 as depicted in FIG. 13. An insulator is preferably disposed between upper base 201-1 of trapezoidal component 201 and bar component 202.

FIG. 19 shows a top view of flat antenna 200 depicted in FIG. 18. FIG. 19 shows the design parameters, C₁, C₂, L, φ, S and D, for trapezoidal component 201 and bar component 202. All the parameters preferably correspond to the parameters for antenna 100 depicted in FIG. 9. As such, the distance S between disc 102 and cone 101 of antenna 100 of the present invention, shown in FIG. 9, preferably corresponds to the distance between bar component 202 and trapezoidal component 201. The diameter D of disc 102 preferably corresponds to the length of bar component 202. The cone angle φ of the cone slope preferably corresponds to the cone angle of trapezoidal component 201. The maximum diameter C₁ of cone 101 preferably corresponds to the length of lower base 201-2 of trapezoidal component 201. The minimum diameter C₂ of cone 101 preferably corresponds to the length of upper base 201-1 of trapezoidal component 201. The design parameters for flat antenna 200, C₁, C₂, L, φ, S and D, preferably satisfy the following equations such that the most desirable results are obtained.
S, the distance between bar component 202 and trapezoidal component 201, is preferably determined by S=0.3×C₁ Equation 4
D, the length of bar component 202, is preferably determined by D=0.7×C₁ Equation 5
φ, the cone angle of trapezoidal component 201, is preferably determined by φ=60° Equation 6

Although any type of cable can be used to connect the various elements of the present invention, coaxial cable is preferably used as feeding cable 203 in this example and the cable preferably has center conductor 203-1 of which is covered with an insulative layer, and may be used as shown in FIG. 11.

In this example, center conductor 203-1 is preferably insulated from and not connected electrically to trapezoidal component 201.

In addition, bar component 202 of antenna 200 is preferably constructed from a rectangular parallelepiped component, but it need not be limited to this shape, and cylindrical, polygonal, and other shapes can be used and will produce desirable results. Further, the conductor of the cable itself can also be used as bar component 202.

In spite of the compact size compared to the above antenna 100, which has the above disc and the cone, flat antenna 200 realizes wide bandwidth and high gains. It also reduces noise, thus improving the S/N ratio over a broadband.

### Example 16

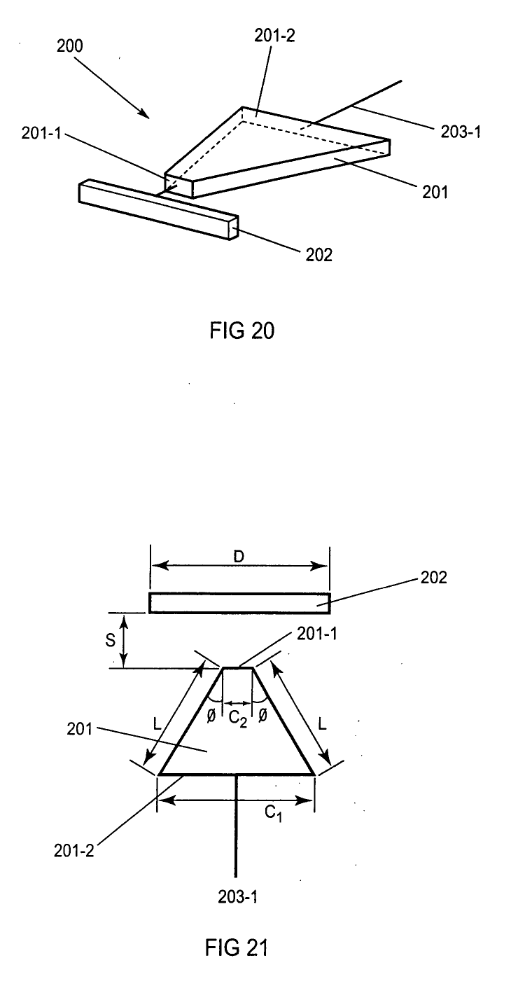

FIGS. 20 and 21 show a variation of antenna used for antenna apparatus of the present invention. As depicted therein, flat antenna 200 has trapezoidal component 201 with a thickness and bar component 202, which is disposed near and parallel with base 201-1 of trapezoidal component 201. Conductor 203-1 is connected electrically to lower base 201-2 of trapezoidal component 201.

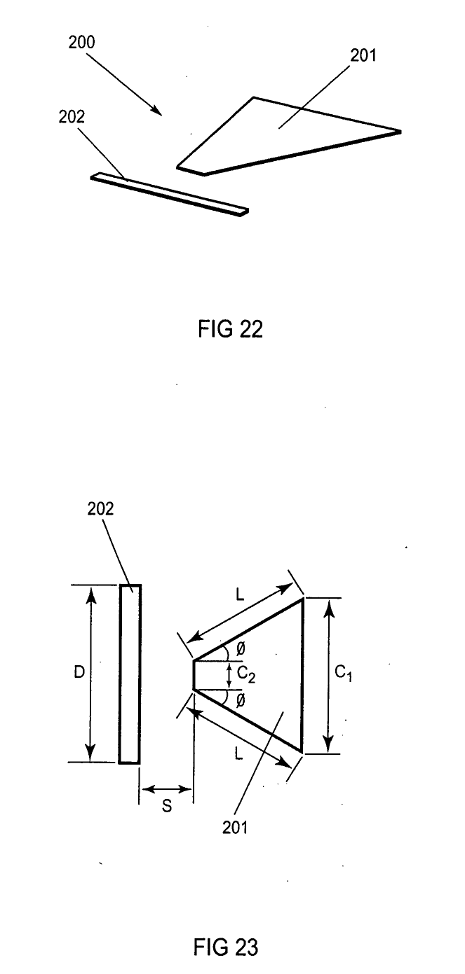

FIG. 21 shows a top view of flat antenna 200 and illustrates the design parameters C1, C2, L, φ, S and D. All the parameters are preferably determined such that they satisfy Equations 4, 5, and 6. FIG. 22 shows antenna 200 in which the thickness of trapezoidal component 201 and bar component 202 may be reduced down to as thin as a foil thickness. FIG. 21 shows that the design parameters for flat antenna C₁, C₂, L, φ, S and D are most desirable according to Equations 4, 5, and 6. Instead of using a trapezoidal shaped component in this example, triangle component 201, preferably has no upper base. In addition, bar component 202 of this embodiment of flat antenna 200, depicted in FIG. 20, is preferably constructed from a rectangular parallelepiped component, but the component need not be limited to this shape, and cylindrical, polygonal, and other shapes can be used and will produce desirable results. Further, the conductor of the cable itself can also be used as a bar component 202.

In spite of the compact size of the antenna depicted in FIG. 20, the antenna is capable of realizing a wide bandwidth and high gains, as well as reducing noise and thus improving the S/N ratio.

### EXAMPLE 17

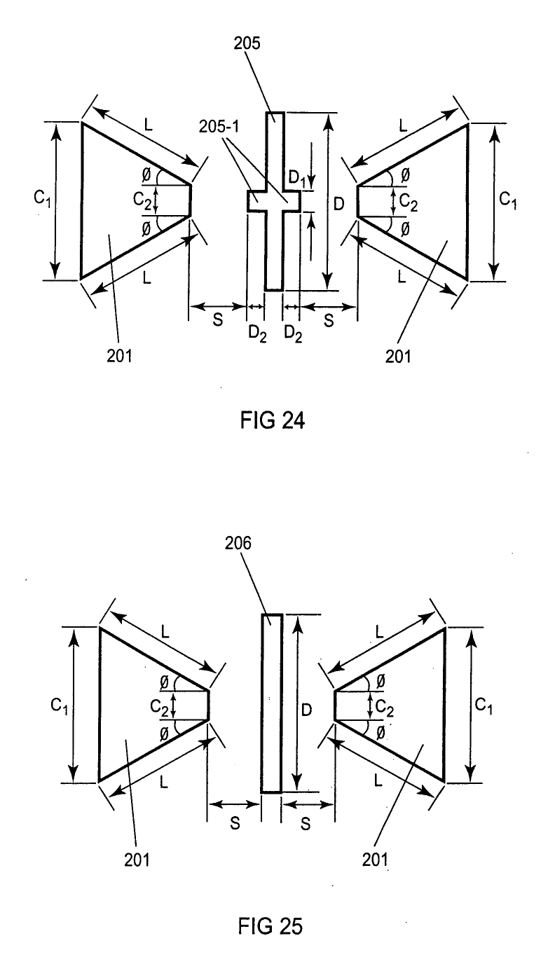

In this example, the antenna preferably comprises two flat antennas, as depicted in FIGS. 22 or 23. FIG. 24 shows the antenna apparatus of this example which has two trapezoidal components 201 as well as cross-shape component 205. According to this embodiment, two trapezoidal components are preferably disposed opposite one another with cross-shape component 205 disposed therebetween.

The design parameters for flat antenna 200 of this embodiment preferably satisfy Equations 4, 5, and 6. The length D of cross shaped component 205 preferably corresponds to the length of bar component 202, shown in FIG. 21 and FIG. 23. The height D₂ of the horizontal bar of cross-shaped component 205 is preferably designed to control the distance S between the flat antenna and cross-shaped component 205.

FIG. 25 shows bar component 206 which is optionally used instead of cross-shaped component 205. Bar component 206 of the antenna is not limited to only a rectangular parallelepiped component, rather a cylinder shape, polygonal shape, and other shapes can be used. The conductor of the cable can also be used to construct bar component 206.

FIGS. 24 and 25 show flat antennas 201, which have no feeding cable. Rather, center conductor 203-1, as shown in FIG. 20, is preferably used for this embodiment of the antenna apparatus of the present invention.

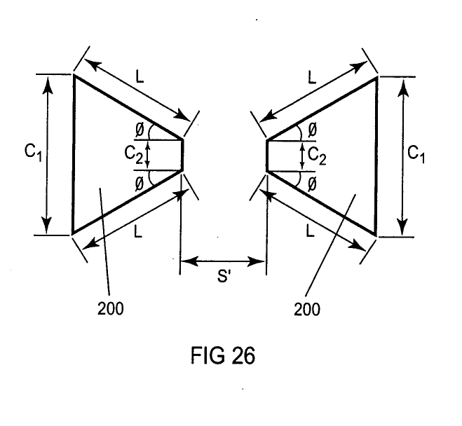

FIG. 26 shows a configuration of two trapezoidal shaped flat antennas 201, each upper base of which is preferably disposed opposite the other upper base instead of using cross-shaped component 205 or bar component 206. In this case, the distance S′ between two flat antennas preferably corresponds to S in Equation 4 and can be designed to include some adequate adjustment as those skilled in the art will readily recognize.

The preceding examples can be repeated with similar success by substituting the generically or specifically described operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended daims all such modifications and equivalents. The entire disclosures of all references, applications, patents, and publications cited above and/or in the attachments, and of the corresponding application(s), are hereby incorporated by reference.

1. An electromagnetic waveguide comprising:
a first antenna, said first antenna disposed in an area where a transmitted signal is weak;
a second antenna disposed in an area where a transmitted signal is stronger than in said first area; and
a conductor electrically connecting said first and said second antennas.

2. The waveguide of claim 1 wherein at least one of said antennas comprises an antenna having a wide bandwidth.

3. The waveguide of claim 1 wherein at least one of said antennas comprises a discone antenna.

4. The waveguide of claim 1 wherein said first antenna comprises an assembly of more than one antenna.

5. The waveguide of claim 1 wherein said second antenna comprises an assembly of more than one antenna.

6. The waveguide of claim 1 wherein all of said antennas comprise discone antennas.

7. The waveguide of claim 1 wherein said first antenna is disposed in an inner portion of a building.

8. The waveguide of claim 1 wherein said second antenna is disposed near an outer portion of a building.

9. The waveguide of claim 1 wherein said second antenna is disposed on an outer portion of a building.

10. The waveguide of claim 1 wherein said second antenna is disposed outside of a building.

11. The waveguide of claim 1 wherein said first antenna is disposed within an internal portion of a building and said second antenna is not disposed in an internal portion of said building.

12. The waveguide of claim 1 further comprising third and fourth antennas electrically connected together.

13. The waveguide of claim 12 wherein at least one of said antennas comprises an antenna having a wide bandwidth.

14. The waveguide of claim 12 wherein at least one of said antennas comprises a discone antenna.

15. The waveguide of claim 12 wherein all of said antennas comprise discone antennas.

16. The waveguide of claim 12 wherein said third antenna is disposed in an inner portion of a building.

17. The waveguide of claim 12 wherein said fourth antenna is disposed near an outer portion of a building.

18. The waveguide of claim 12 wherein said fourth antenna is disposed on an outer portion of a building.

19. The waveguide of claim 12 wherein said fourth antenna is disposed outside of a building.

20. The waveguide of claim 12 wherein said third antenna is disposed within an internal portion of a building and said fourth antenna is not disposed in an internal portion of said building.

21. The waveguide of claim 12 wherein said first and said third antennas are disposed within an internal portion of a building and said second and said fourth antennas are not disposed in an internal portion of said building.

22. The waveguide of claim 12 wherein said third antenna comprises an assembly of more than one antenna.

23. The waveguide of claim 12 wherein said fourth antenna comprises an assembly of more than one antenna.

24. A method for improving transmission and/or reception of devices which communicate via electromagnetic waves, the method comprising the steps of:
disposing a first antenna in a first area, the first area being an area where electromagnetic wave transmission and/or reception is desired to be improved;
disposing a second antenna in a second area where transmission and/or reception capabilities are better than the first area; and
connecting the first and second antennas with an electrical conductor.

25. The method of claim 24 wherein at least one of the disposing steps comprises disposing an antenna having a wide bandwidth.

26. The method of claim 24 wherein at least one of the disposing steps comprises disposing a discone antenna.

27. The method of claim 24 wherein each of the disposing steps comprises disposing a discone antenna.

28. The method of claim 24 wherein at least one of the disposing steps comprises disposing an assembly of antennas.

29. The method of claim 24 wherein each of the disposing steps comprises disposing an assembly of antennas.

30. The method of claim 24 where the first area comprises an area within a building.

31. The method of claim 24 wherein the second area comprises a non-internal portion of a building.

32. The method of claim 24 further comprising the step of providing a third and fourth antenna electrically connected to one another.

33. The method of claim 32 further comprising the step of disposing the third antenna in the first area.

34. The method of claim 32 further comprising the step of disposing the fourth antenna in the second area.

35. The method of claim 32 wherein at least one of the disposing steps comprises disposing an antenna having a wide bandwidth.

36. The method of claim 32 wherein at least one of the disposing steps comprises disposing a discone antenna.

37. The method of claim 32 wherein all of the disposing steps comprise disposing discone antennas.

38. An antenna apparatus comprising:
two cones, each cone having an apex and a base;
two discs, each of said discs corresponding to a respective cone, each of said discs disposed adjacent said apex of said respective cone; and
an electrical conductor, at least partially disposed inside of said cones, wherein said conductor electrically connects said discs.

39. An antenna apparatus comprising a plurality of antennas, each antenna comprising:
a cone comprising an apex and a base;
a disc disposed near said apex of said cone; and
an electrically conductive cable, said cable in electrical contact with said disc, and said conductors of said plurality of antennas connected electrically in series.

40. The apparatus of claim 39 wherein at least a portion of at least one cable is disposed within at least one of said cones.
